(19) United States
(12) Patent Application Publication
(10) Pub. No.: US 2009/0276716 A1
(43) Pub. Date: Nov. 5, 2009

(54) Content Adaptation

(75) Inventor: Hui N. Chua, Kuala Lumpur (MY)

Correspondence Address: NIXON & VANDERHYE, PC, 901 NORTH GLEBE ROAD, 11TH FLOOR, ARLINGTON, VA, 22203, US

(73) Assignee: BRITISH TELECOMMUNICATIONS PUBLIC LIMITED COMPANY, LONDON (GB)

(21) Appl. No.: 11/887,395

(22) PCT Filed: Mar. 16, 2006
(86) PCT No.: PCT/GB2006/000393

§ 371 Date: Sep. 28, 2007

(30) Foreign Application Priority Data
Mar. 29, 2005 (MY) P120051375

(51) Int. Cl. G06F 3/00; G06F 17/30

(52) U.S. Cl. 715/744; 707/100; 707/E17.044

(57) ABSTRACT

A web page content adaptation process and system which prioritizes requested web page content for adaptation in accordance with a user's level of interest in the web page content is described. The requested web page content is grouped to form multiple content clusters and a priority value is assigned to each of the content clusters based on the user's browser history. The requested web page content is then adapted in order of the priority value assigned to each of the content clusters to provide a useful version of the original web page content.

### TECHNICAL FIELD

The present invention relates to web page content adaptation, and more particularly to a system and process for prioritising web page content for adaptation.

### BACKGROUND TO THE INVENTION AND PRIOR ART

With the increasing availability of small, web-enabled microcomputer devices such as Personal Digital Assistants (PDAs) and mobile phones, more and more people are now accessing the internet from these microcomputer devices. However, because web page content is predominantly designed for display on personal computers (PCs), web page content is often unsuitable for viewing on microcomputer devices as these client devices do not have the same rendering capabilities as PCs. Therefore, it is often necessary to adapt web page content into an appropriate form for proper presentation on a microcomputer device.

Web page content adaptation, also known as transcoding, typically involves performing multimedia object transformations and content splitting. Commonly employed multimedia object transformations include shrinking the size of a web object by, for example, reducing font size or colour depth, summarising web page content and removing unimportant portions of web page content. Content splitting involves adapting web page content to fit a minimal number of pages, while at the same time, minimising the amount of white space on each page.

However, due to the physical and performance limitations of microcomputer devices such as, for example, smaller screen size, smaller memory size, and lower connection bandwidth, mere adaptation of web page content through multimedia object transformations and content splitting is typically not sufficient for efficient provision of requested web page content. For example, due to screen size constraints, web page content authored for display as a single page on the screen of a desktop computer having a resolution of 800×600 pixels may have to be split up into a number of pages when displayed on a PDA screen having a resolution of 240×320 pixels. This inconveniences the PDA user as he may have to scroll through a number of pages on his PDA before locating the specific web page content which he requires.

In view of the foregoing, there is a need for a further approach which produces appropriate versions of web page content to suit client device capabilities based on a user's level of interest in the requested web page content.

### SUMMARY OF THE INVENTION

In order to meet the above, the present invention provides a web page content adaptation process and system which prioritises requested web page content for adaptation in accordance with a user's level of Interest in the web page content. Because the semantics of the requested web page content is taken into consideration during the prioritisation process, the present invention provides a meaningful version of the original web page content. Moreover, as the user's level of interest in the requested web page content is measured in real time, the adapted web page content provided by the present invention is up-to-date with the user's current interests.

In view of the above, from a first aspect there is provided a process for adapting web page content into an appropriate form for display on a client device, the process comprising the steps of: receiving a request for web page content; retrieving the requested web page content from a content database, wherein web page content stored in the content database is grouped to form multiple content clusters; assigning a priority value to each of the content clusters in the requested web page content based on browser history; and adapting the requested web page content in order of the priority value assigned to each of the content clusters.

The invention according to the first aspect provides the advantages set out above.

In a preferred embodiment, the web page content stored in the content database is categorised into one or more content categories. This facilitates identification of user Interest in the web page content.

A utility value is preferably determined for each of the one or more content categories in the content database. This provides a measure of the strength of user interest in the web page content.

Additionally, preferably the utility value of each of the one or more content categories in the content database is matched with respective ones of the one or more content categories in the requested web page content. This provides a measure of the strength of user interest in the requested web page content.

Furthermore, preferably the utility value of each of the one or more content categories in respective ones of the content clusters in the requested web page content is summed to obtain a total utility value for the respective ones of the content clusters. This facilitates the calculation of the priority value for each content cluster in the requested web page content. A higher priority value is preferably assigned to the respective ones of the content clusters having a greater total utility value.

In another preferred embodiment, the web page, content stored in the content database is grouped by inserting a tag in each of the content clusters. Additionally, a content category attribute is preferably inserted into the tag. Again, this facilitates identification of user interest in the web page content. Further, a priority value attribute is preferably inserted into the tag. This is useful in performing the adaptation step.

In yet another preferred embodiment, the web page content is grouped based on semantics. This facilitates the provision of a meaningful version of the original web page content.

From a second aspect, the invention further provides a web page content adaptation system, the system comprising: a content database for storing web page content; processing means arranged to receive a request for web page content and to retrieve the requested web page content from the content database, wherein the web page content stored in the content database is grouped to form multiple content clusters; calculation means arranged to assign a priority value to each of the content clusters in the requested web page content based on browser history; and adaptation means arranged to adapt the requested web page content in order of the priority value assigned to each of the content clusters.

In the second aspect, corresponding advantages are obtained as previously described in respect of the first aspect. Moreover, corresponding further features as described above in respect of the first aspect may also be employed.

From a third aspect, the present invention further provides a computer program or suite of programs so arranged such that when executed by a computer system it/they cause/s the system to perform the process of any of the preceding claims. The computer program or programs may be embodied by a modulated carrier signal incorporating data corresponding to the computer program or at least one of the suite of programs, for example a signal being carried over a network such as the Internet.

Additionally, from a yet further aspect the invention also provides a computer readable storage medium storing a computer program or at least one of suite of computer programs according to the third aspect. The computer readable storage medium may be any magnetic, optical, magneto-optical, solid-state, or other storage medium capable of being read by a computer.

Other aspects and advantages of the invention will become apparent from the following detailed description, taken in conjunction with the accompanying drawings, illustrating by way of example the principles of the invention.

### BRIEF DESCRIPTION OF THE DRAWINGS

The following detailed description of preferred embodiments of the invention will be better understood when read in conjunction with the appended drawings. The present invention is illustrated by way of example and is not limited by the accompanying figures, in which like references indicate similar elements.

FIG. 1 is a block diagram illustrating a web page content adaptation system in accordance with an embodiment of the present invention;

FIG. 2 is a web page illustrating the clustering and categorisation of web page content in accordance with an embodiment of the present invention; and

FIG. 3 is a table illustrating the calculation of a priority value for each content cluster in the requested web page content in accordance with an embodiment of the present invention.

### DETAILED DESCRIPTION OF THE PREFERRED EMBODIMENTS

A system and method for prioritising web page content for adaptation are provided. In the following description, numerous specific details are set forth in order to provide a thorough understanding of the present invention. It will be understood, however, to one skilled in the art, that the present invention may be practiced without some or all of these specific details. In other instances, well known process operations have not been described in detail in order not to unnecessarily obscure the present invention.

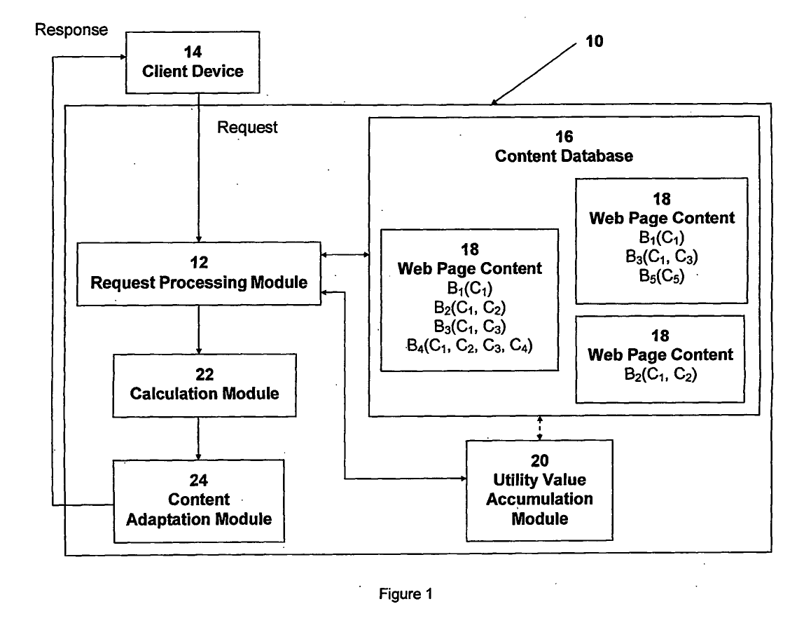

FIG. 1 is a block diagram of a web page content adaptation system 10. The system 10 includes a request processing module 12 arranged to receive a request for web page content from a client device 14, and to retrieve the requested web page content from a content database 16 in which web page content 18 is stored. The web page content 18 stored in the content database 16 includes a plurality of web objects such as, for example, text and images. The web page content 18 is grouped, based on the semantics of the web objects, to form multiple content clusters Bₖ and categorised into one or more content categories Cₗ. The system 10 also includes a utility value accumulation module 20 arranged to determine a utility value Vcᵢuⱼ for each of the content categories Cₗ, a calculation module 22 arranged to assign a priority value to each of the content clusters Bₖ in the requested web page content based on browser history, and a content adaptation module 24 arranged to adapt the requested web page content, in order of the priority value assigned to each of the content clusters Bₖ, into an appropriate form for display on the client device 14. Those of skill in the art will understand that the system 10 would most likely be embodied in a computer system acting as a web server or the like. Alternatively, the system 10 can be embodied in a computer system, or the components as shown in FIG. 1 can be embodied in separate computer systems but one computer system acts as a web server to the other computer systems.

Having described the various system modules provided by the embodiment of the present invention, the operation of those modules will now be described in further detail in the following paragraphs.

A request for web page content is sent by the client device 14 to the request processing module 12 when, for example, a user Uⱼ enters the Universal Resource Identifier (URI) of a web page into a browser window of the client device 14 or when the user Uⱼ activates a hyperlink on a web page displayed in the browser window of the client device 14. The client device 14 may be a personal computer (PC) or a small, web-enabled microcomputer device such as, for example, a Personal Digital Assistant (PDA) or a mobile phone.

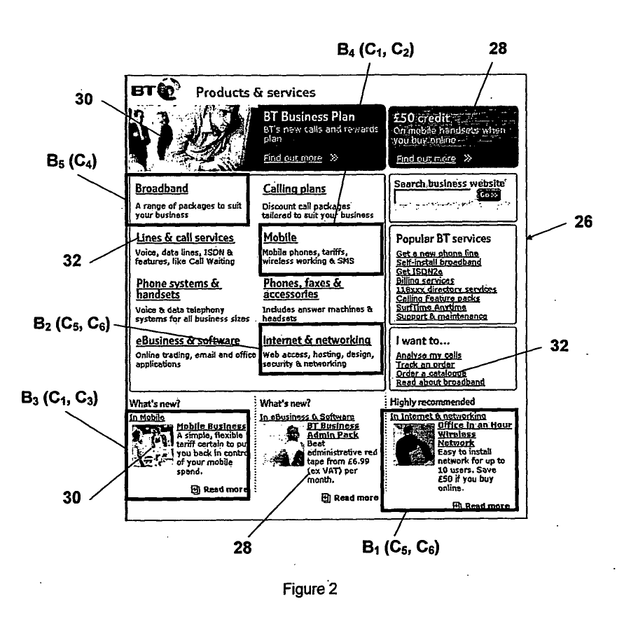

On receiving the request from the client device 14, the request processing module 12 parses the request and retrieves the requested web page content from the content database 16. As previously described, the web page content 18 stored in the content database 16 is grouped, based on semantics, into multiple content clusters Bₖ. Accordingly, the web page content 18 in each content cluster Bₖ provides semantic information about the content cluster Bₖ. As can be seen from FIG. 1, the web page content 18 in each content cluster Bₖ is further categorised into one or more content categories Cₗ. Each content category Cₗ represents a domain of user or group interest. Grouping the web page content 18 to form content clusters and further categorising the web page content 18 into content categories facilitates identification of a user's interest and calculation of the strength of that interest. An example of how web page content is grouped and categorised is shown in FIG. 2.

Referring now to FIG. 2, a web page 26 having web page content in the form of text 28, images 30 and hyperlinks 32 is provided is shown. The web page content is semantically grouped into a plurality of content clusters B₁, B₂, B₃, B₄ and B₅. The web page content in each of the content clusters B₁, B₂, B₃, B₄ and B₅ is further categorised into one or more content categories C₁, C₂, C₃, C₄, C₅ and C₆. Each content category is a domain of user or group interest and is represented by a keyword. In this particular example, the content categories C₁, C₂, C₃, C₄, C₅ and C₆ are represented by the keywords “Mobile”, “Wireless”, “Business”, “Broadband”, “Internet” and “Networking”, respectively. Accordingly, the web page content in content clusters B₁ and B₂ is categorised under the content categories “Internet” and “Networking”, those in content cluster B₃ under the content category “Mobile” and “Business”, those in content cluster B₄ under the content category “Mobile” and “Wireless”, while those in content cluster B₅ are categorised under the content category “Broadband”. As can be seen from FIG. 2, each content cluster B₁, B₂, B₃, B₄ and B₅ can accommodate one or more content categories C₁, C₂, C₃, C₄, C₅ and C₆.

Referring back to FIG. 1, each of the content clusters Bₖ in the content database 16 includes a tag to group the web page content 18. An example of a portion of the syntax of a tagged web page is shown in Table 1.

TABLE 1

...
<cluster name=”B1” category=”C1,C2,C3”> ... </cluster>
<cluster name=”B2” category=”C5,C6”> ... </cluster>
<cluster name=”B3” category=”C1,C2”> ... </cluster>
<cluster name=”B4” category=”C0,C1,C2,C4”> ... </cluster>
<cluster name=”B5” category=”C5”> ... </cluster>
<cluster name=”B6” category=”C4”> ... </cluster>
<cluster name=”B7” category=”C3”> ... </cluster>
...

In this particular example, a tag, <cluster>, is inserted ahead of a group of web page objects making up a content cluster Bₖ and a closing tag, </cluster>, is inserted after this group of web objects. To distinguish between the content clusters Bₖ, a cluster name attribute, name, is included in the tag, <cluster>. Additionally, the tag, <cluster>, includes a content category attribute, category, to categorise the web page content 18 in the content clusters Bₖ into one or more content categories Cₗ. Tagging of the web page content 18 to form the content clusters Bₖ may be done manually by a website administrator or an author of the web page. Alternatively, the web page content 18 stored in the content database 16 may be grouped to form multiple content clusters Bₖ via an automated process, using an algorithm to perform a semantic analysis of a given web page to identify clusters of information, and to tag each cluster of information identified, as is known by those of skill in the art. In this particular example, the web page content 18 is grouped prior to storage in the content database 16. However, it should be understood that the present invention is not limited by such an arrangement. The web page content 18 may, for example, be grouped on receipt of a request for web page content. That is, it could be done on the fly as the web content is retrieved and before it is passed to the requestor.

After retrieving the requested web page content from the content database 16, the request processing module 12 passes a list of the content categories Cₗ in the requested web page content and the user's identity, represented by an Internet protocol (IP) address of the client device 14, to the utility value accumulation module 20 to determine a utility value Vcᵢuⱼ for each of the content categories Cₗ. The utility value Vcᵢuⱼ reflects the usefulness of a particular content category Cₗ to a specific user Uⱼ, and the level of interest that specific user Uⱼ has in that particular content category Cₗ. The utility value Vcᵢuⱼ of a particular content category Cₗ is directly proportional to the number of times that particular content category Cₗ is requested by a specific user Uⱼ; the utility value Vcᵢuⱼ of a content category Cₗ that has never been requested by the user Uⱼ is zero. Accordingly, in determining a utility value Vcᵢuⱼ for each of the content categories Cₗ in the requested web page content, the utility value accumulation module 20 performs a click-stream analysis, taking into account the browser history of a specific user Uⱼ, to ascertain the number of times each content category Cₗ is requested by the user Uⱼ. The browser history of a specific user Uⱼ provides Information on the number of times a particular content category Cₗ is requested by that specific user Uⱼ. In this particular example, the browser histories of a plurality of users Uⱼ are stored in the utility value accumulation module 20 and accessed when determining a utility value Vcᵢuⱼ for each of the content categories Cₗ in the requested web page content. Nonetheless, it should be understood that the present invention is not limited by the location in which the browser histories are stored. For example, in an alternative embodiment, the browser histories may be stored in the content database 16 and accessed by the utility value accumulation module 20 when determining a utility value Vcᵢuⱼ for each of the content categories Cₗ in the requested web page content (see dashed arrow between the content database 16 and the utility value accumulation module 20 in FIG. 1). The newly determined utility value Vcᵢuⱼ of each content category Cₗ is then returned to the request processing module 12.

Thereafter, the request processing module 12 passes the requested web page content, the list of content categories Cₗ in the requested web page content and the utility values Vcᵢuⱼ to the calculation module 22 where the priority values for each content cluster Bₖ in the requested web page content are calculated and assigned.

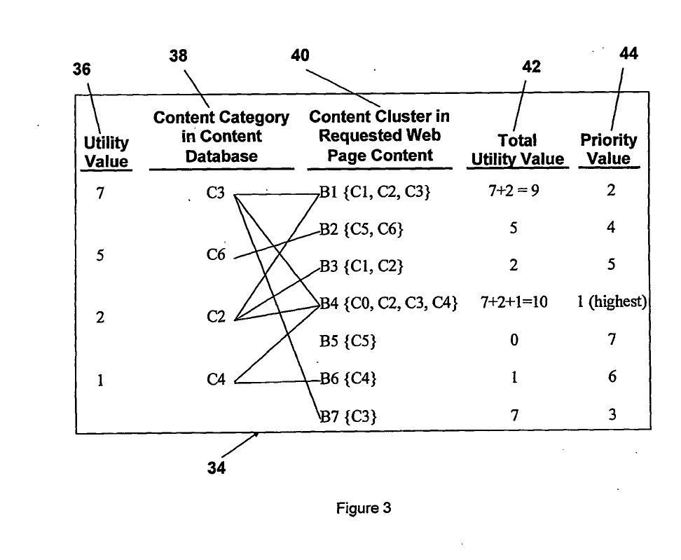

The priority value represents the level of importance of a content cluster Bₖ in the requested web page content. The process of calculating and assigning priority values involves matching the utility value Vcᵢuⱼ of each of the content categories Cₗ in the content database 16 with respective ones of the content categories Cₗ in the requested web page content, summing the utility value Vcᵢuⱼ of each of the content categories Cₗ in respective ones of the content clusters Bₖ in the requested web page content to obtain a total utility value for respective ones of the content clusters Bₖ, and assigning a higher priority value to the content clusters Bₖ with a greater total utility value. An exemplary approach to calculating a priority value for each content cluster Bₖ in the requested web page content is illustrated in FIG. 3.

Referring now to FIG. 3, a table 34 with five (5) columns is provided as shown. A first column 36 stores utility values Vcᵢuⱼ determined by the utility value accumulation module 20, while the corresponding content categories C₃, C₆, C₂ and C₄ in the content database 16 in respect of which these utility values Vcᵢuⱼ were determined are stored in a second column 38. In this particular example, content category C₃ is determined to have a utility value of 7, content category C₆ is determined to have a utility value of 5, content category C₂ is determined to have a utility value of 2, while content category C₄ is determined to have a utility value of 1. Content categories C₀, C₁, and C₅, in this particular example, have never before been requested by the user Uⱼ and therefore have zero (0) utility value.

Each of the content clusters B₁, B₂, B₃, B₄, B₅, B₆ and B₇ in the requested web page content and their respective content categories C₀, C₁, C₂, C₃, C₄, C₅ and C₆ are listed in a third column 40. A strings matching function, as is known by those of skill in the art, is applied to match the utility value Vcᵢuⱼ of each content category C₃, C₆, C₂ and C₄ in the content database 16 with respective ones of the content categories C₀, C₁, C₂, C₃, C₄, C₅ and C₆ in content clusters B₁, B₂, B₃, B₄, B₅, B₆ and B₇. Accordingly, content category C₃ in the content database 16 is matched with content clusters B₁, B₄ and B₇, content category C₆ is matched with content cluster B₂, content category C₂ is matched with content clusters B₁, B₃ and B₄, while content category C₄ is matched with content cluster B₄ and B₆.

The total utility value for each content cluster B₁, B₂, B₃, B₄, B₅, B₆ and B₇ in the requested web page, shown in a fourth column 42 of the table 34, is then obtained by summing the utility value Vcᵢuⱼ of each of the content categories C₀, C₁, C₂, C₃, C₄, C₅ and C₆ in respective ones of the content clusters B₁, B₂, B₃, B₄, B₅, B₆ and B₇. For example, the total utility value for content cluster B₁, derived from a summation of the utility values Vcᵢuⱼ of the content categories C₁, C₂ and C₃ in the content database 16, is 9. The total utility values for content clusters B₂, B₃, B₄, B₅, B₆ and B₇, similarly derived, are 5, 2, 10, 0, 1 and 7, respectively.

Once the total utility value for each content cluster B₁, B₂, B₃, B₄, B₅, B₆ and B₇ is calculated, a priority value, shown in a fifth column 44 of the table 34, is assigned to each of the content clusters B₁, B₂, B₃, B₄, B₅, B₆ and B₇. As can be seen from the table 34, a higher priority value is assigned to respective ones of the content clusters B₁, B₂, B₃, B₄, B₅, B₆ and B₇ with a greater total utility value. For example, content cluster B₄, which has the largest total utility value, is assigned the highest priority value, namely 1, while content cluster B₅, which has the smallest total utility value, is assigned the lowest priority value, namely 7.

Referring back to FIG. 1, the priority value is included as a priority value attribute, priority, in the tag to facilitate the subsequent adaptation step. Continuing with the exemplary syntax provided in Table 1, an example of a portion of the syntax of a tagged web page with a priority value attribute, priority, is shown in Table 2.

TABLE 2

...
<cluster name=”B1” character=”C1,C2,C3” priority=”2”> ...
</cluster>
<cluster name=”B2” character=”C5,C6” priority=”4”> ...
</cluster>
<cluster name=”B3” character=”C1,C2” priority=”5”> ...
</cluster>
<cluster name=”B4” character=”C0,C1,C2,C4” priority=”1”> ...
</cluster>
<cluster name=”B5” character=”C5” priority=”7”> ... </cluster>
<cluster name=”B6” character=”C4” priority=”6”> ... </cluster>
<cluster name=”B7” character=”C3” priority=”3”> ... </cluster>
...

The priority value attribute, priority, is inserted into the tag, <cluster>, using a greedy algorithm to map a priority value to a relevant content cluster tag and to set the priority value into the relevant content cluster tag once located. Specifically, the greedy algorithm involves performing a depth-first walk through the requested web page content to locate the relevant content cluster tag and to set the priority value into the priority value attribute, priority, once the relevant content cluster tag is located. An example of an algorithm (pseudo java code) for assigning a priority value to a content cluster Bₖ is shown in Table 3.

TABLE 3

| String X; | // Cluster name; |
|---|---|
| Integer Y; | // Priority value of X; |
| ArrayList AP[X,Y]; | // Array storing a list of clusters & |
| | // their priority value sort ascending. |
| Integer C; | // Number of rows in AP list. |
| Stack Q; | // Temporary tree holding the tree nodes to |
| | // be processed. |
| Stack R; | // Stack to hold repositioned tree nodes. |
| Node N; | // A temporary node. |
| Q.push(top_node); | // Add the top <cluster> node in the XML |
| | // compliant tree to stack Q. |

If (Q.size > 0)

| { | For Loop (i=0; i<C; i++) | |
|---|---|---|
| | { | While (Q.size > 0) |

| | |
|---|---|
| { | N = Q.pop( ); |

// Take the top node off the stack.

If (N.nodeName = ”cluster”) &&

N.getAttribute(“name”).
matchString(AP[i,0] <= 0)

// Check if it is a <cluster> tag
// node and its attribute “name”
// value matches with the stored
// value.

| | |
|---|---|
| { | N.setAttribute(“priority”)= AP[i,1]; |

// Set priority value

R.push(getAllChildOf(N));

// Get all children of N
// then add into R.

go to point1;

}
Else

Q.push(N);

// Put back unmatched node into Q.

}
point1;

}

}

where:

matchstring (AP[i,0]<=0) is a function to check if the cluster name attribute, name, matches the value stored in the array, AP[i,0]; and

getAllChildOf (N) is a recursive function to get all the child nodes under a given node, N.

After the priority values are assigned to the respective content clusters Bₖ, the requested web page content is passed to the content adaptation module 24 where the requested web page content undergoes multimedia object transformations and content splitting, in order of the priority value assigned to each of the content clusters Bₖ, before the requested web page content is sent back as a response to the client device 14 in an appropriate form for display.

As is evident from the foregoing discussion, the present invention provides a web page content adaptation process and system which prioritises requested web page content for adaptation in accordance with a user's level of interest in the web page content. Because the semantics of the requested web page content is taken into consideration during the prioritisation process, the present invention provides a meaningful version of the original web page content. Moreover, as the user's level of interest in the requested web page content is measured in real time, the adapted web page content provided by the present invention is up-to-date with the user's current interests.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

Further, unless the context dearly requires otherwise, throughout the description and the claims, the words “comprise”, “comprising” and the like are to be construed in an inclusive as opposed to an exclusive or exhaustive sense; that is to say, in the sense of “including, but not limited to”.

1. A process for adapting web page content into an appropriate form for display on a client device, the process comprising the steps of: receiving a request for web page content; and either retrieving the requested web page content from a content database, wherein web page content stored in the content database is grouped to form multiple content clusters, or retrieving the requested web page content from a content database and identifying within the retrieved web page content multiple content clusters; assigning a priority value to each of the content clusters in the requested web page content based on browser history; and adapting the requested web page content in order of the priority value assigned to each of the content clusters.

2. A process according to claim 1, wherein the web page content stored in the content database is categorized into one or more content categories.

3. A process according to claim 2, further comprising the step of determining a utility value for each of the one or more content categories in the content database.

4. A process according to claim 3, further comprising the step of matching the utility value of each of the one or more content categories in the content database with respective ones of the one or more content categories in the requested web page content.

5. A process according to claim 4, further comprising the step of summing the utility value of each of the one or more content categories in respective ones of the content clusters in the requested web page content to obtain a total utility value for the respective ones of the content clusters.

6. A process according to claim 5, wherein a higher priority value is assigned to the respective ones of the content clusters having a greater total utility value.

7. A process according to claim 1, wherein the web page content stored in the content database is grouped by inserting a tag in each of the content clusters.

8. A process according to claim 7, further comprising inserting a content category attribute into the tag.

9. A process according to claim 7, further comprising inserting a priority value attribute into the tag.

10. process according to claim 1, wherein the web page content is grouped based on semantics.

11. A computer program or suite of programs so arranged such that when executed by a computer system it/they cause/s the system to perform the process of any of the preceding claims.

12. A modulated carrier signal incorporating data corresponding to the computer program or at least one of the suite of programs of claim 11.

13. A computer readable storage medium storing a computer program or at least one of suite of computer programs according to claim 11.

14. A web page content adaptation system, the system comprising:
a content database for storing web page content;
processing means arranged to receive a request for web page content and to retrieve the requested web page content from the content database, wherein the web page content stored in the content database is grouped to form multiple content clusters;
calculation means arranged to assign a priority value to each of the content clusters in the requested web page content based on browser history; and
adaptation means arranged to adapt the requested web page content in order of the priority value assigned to each of the content clusters.

15. A system according to claim 14, wherein the web page content stored in the content database is categorized into one or more content categories.

16. A system according to claim 15, further comprising a utility value accumulation means arranged to determine a utility value for each of the one or more content categories in the content database.

17. A system according to claim 16, wherein the calculation means is further arranged to match the utility value of each of the one or more content categories in the content database with respective ones of the one or more content categories in the requested web page content.

18. A system according to claim 17, wherein the calculation means is further arranged to sum the utility value of each of the one or more content categories in respective ones of the content clusters in the requested web page content to obtain a total utility value for the respective ones of the content clusters.

19. A system according to claim 18, wherein the calculation means is further arranged to assign a higher priority value to the respective ones of the content clusters having a greater total utility value.

20. A system according to claim 14, wherein each of the content clusters in the content database includes a tag to group the web page content.

21. A system according to claim 20, wherein the tag includes a content category attribute to categorize the web page content in the content clusters into one or more content categories.

22. A system according to claim 20, wherein the tag includes a priority value attribute.

23. A system according to claim 14, wherein the web page content is grouped based on semantics.

24. A web page content adaptation system, the system comprising:
a content database for storing web page content;
means arranged to receive a request for web page content and to retrieve the requested web page content from the content database,
processing means arranged to identify within the retrieved web page content multiple content clusters;
calculation means arranged to assign a priority value to each of the content clusters in the requested web page content based on browser history; and
adaptation means arranged to adapt the requested web page content in order of the priority value assigned to each of the content clusters.
